(19) United States
(12) Patent Application Publication
(10) Pub. No.: US 2010/0014662 A1
(43) Pub. Date: Jan. 21, 2010

(54) METHOD, APPARATUS AND COMPUTER PROGRAM PRODUCT FOR PROVIDING TRUSTED STORAGE OF TEMPORARY SUBSCRIBER DATA

(76) Inventor: Sami Antti Jutila, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/142,362

(22) Filed: Jun. 19, 2008

(51) Int. Cl. H04L 9/00

(52) U.S. Cl. 380/44

(57) ABSTRACT

A method for providing trusted storage of temporary subscriber data may include receiving a value indicative of a temporary identity associated with a device, encrypting the value with a randomly generated encryption key to generate an encrypted value, storing the encrypted value in an identity module in removable communication with the device, and storing the encryption key in the device.

### TECHNOLOGICAL FIELD

Embodiments of the present invention relate generally to network communication technology and, more particularly, relate to a method, apparatus and computer program product for providing trusted storage of temporary subscriber data.

### BACKGROUND

Mobile terminals are becoming increasingly ubiquitous in the modern world with ever larger numbers of users of all ages and all levels of sophistication owning or having access to mobile communication and/or processing devices. In an effort to market products to such users in a very competitive marketplace, service providers or network operators have adopted a strategy of offering low cost or even free phones to users. In an effort to ensure that such users engage the network operator thereafter for the provision of services for the low cost or free phones, the phones have typically been locked to the corresponding network operator.

Historically, one mechanism for conducting such “locking” between a phone and a network operator has related to the provision of a subscriber identity module (SIM) lock for a SIM or smart card associated with the phone. The SIM or smart card is often employed to enable the phone to access and utilize many of the phone features and includes identity information specific to the user. In practice, the network operator may institute a SIM lock in a number of ways. However, one common way to provide a SIM lock has been to use International Mobile Subscriber Identity (IMSI) locking. An IMSI is a unique number associated with mobile terminal user. The IMSI is typically stored in the SIM, which may be a removable card, inside the phone and is sent by the phone to the network.

In theory, when the user initially powers up their phone in a network, the IMSI will be transmitted to identify the phone to the service provider. If a valid IMSI (e.g., the IMSI of the network operator to which the phone is to be locked) is provided, the phone can get service from the network operator. However, if the IMSI provided is not the IMSI of the network operator to which the phone is to be locked, then the phone cannot get network service.

A possible problem with the SIM lock mechanism described above has been that it may be relatively easy to insert a device between the SIM card and the mobile terminal device to alter communications therebetween. As such, for example, devices such as the X-SIM have been developed. The X-SIM may make a phone or other mobile terminal useable with a network operator other than the one to which efforts have been made to lock the phone or mobile terminal. The X-SIM may do this by essentially enabling a bypass of the SIM lock. In this regard, for example, the X-SIM may enable the phone to report an IMSI that satisfies the SIM lock conditions.

In order to reduce the likelihood that the user may be identified and/or tracked by a third party, some mobile terminals limit the number of times the IMSI is transmitted. Accordingly, a temporary mobile subscriber identity (TMSI), which is a temporary value associated with a particular location, is often communicated instead. The TMSI is a value that can be changed periodically and whenever the phone enters a different area. If a TMSI is provided that is not valid, then the IMSI may be sent to the network in order to permit network access. In situations where an X-SIM is employed, for example, if the X-SIM is able to bypass the initial IMSI lock, the TMSI is typically used for subscriber identity and thus the phone can be used thereafter, even on a network other than that of the network operator to which the SIM card was locked. One mechanism to provide better protection against the scenario described above could be to clear the TMSI to force the phone to use the IMSI, but this could jeopardize subscriber security.

Accordingly, it may be desirable to provide an improved mechanism for SIM locking that may address at least some of the disadvantages described above.

### BRIEF SUMMARY

A method, apparatus and computer program product are therefore provided to enable providing trusted storage of temporary subscriber data. In this regard, for example, exemplary embodiments of the present invention may provide for encryption of temporary subscriber data such as the TMSI. Accordingly, even if the X-SIM or some similar mechanism could bypass the original smart card locking mechanism, embodiments of the present invention may still enable the detection of the use of a smart card with a network operator to which the smart card is not authorized for use.

In an exemplary embodiment, a method of providing trusted storage of temporary subscriber data is provided. The method may include receiving a value indicative of a temporary identity associated with a device, encrypting the value with a randomly generated encryption key to generate an encrypted value, storing the encrypted value in an identity module in removable communication with the device, and storing the encryption key in the device.

In another exemplary embodiment, a computer program product for providing trusted storage of temporary subscriber data is provided. The computer program product includes at least one computer-readable storage medium having computer-executable program code portions stored therein. The computer-executable program code portions may include first, second, third and fourth program code portions. The first program code portion is for receiving a value indicative of a temporary identity associated with a device. The second program code portion is for encrypting the value with a randomly generated encryption key to generate an encrypted value. The third program code portion is for storing the encrypted value in an identity module in removable communication with the device. The fourth program code portion is for storing the encryption key in the device.

In another exemplary embodiment, an apparatus for providing trusted storage of temporary subscriber data is provided. The apparatus may include a processor. The processor may be configured to receive a value indicative of a temporary identity associated with a device, encrypt the value with a randomly generated encryption key to generate an encrypted value, store the encrypted value in an identity module in removable communication with the device, and store the encryption key in the device.

In yet another exemplary embodiment, an apparatus for providing trusted storage of temporary subscriber data is provided. The apparatus may include means for receiving a value indicative of a temporary identity associated with a device, means for encrypting the value with a randomly generated encryption key to generate an encrypted value, means for storing the encrypted value in an identity module in removable communication with the device, and means for storing the encryption key in the device.

Embodiments of the invention may provide a method, apparatus and computer program product for employment, for example, in mobile environments. As a result, for example, network operators may enjoy improved capacity for maintaining control over devices that they have provided at low or no cost.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for providing trusted storage of temporary subscriber data according to an exemplary embodiment of the present invention; and

FIG. 3 is a flowchart according to an exemplary method for providing trusted storage of temporary subscriber data according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Embodiments of the present invention may be employed to, for example, encrypt temporary stored data that may be associated with device location when such data is stored in a removable storage card associated with user identity data such as a SIM or other smart card. As will be described in greater detail below. Encryption of the temporary stored data (e.g., such as a TMSI or a packet TMSI (PTMSI)) may make the use of an X-SIM card or other like mechanism for bypassing a SIM lock much more difficult to effectively employ. As such, greater security with respect to SIM locking or like mechanisms may be achieved with relatively minimal impact to network devices or SIM cards themselves.

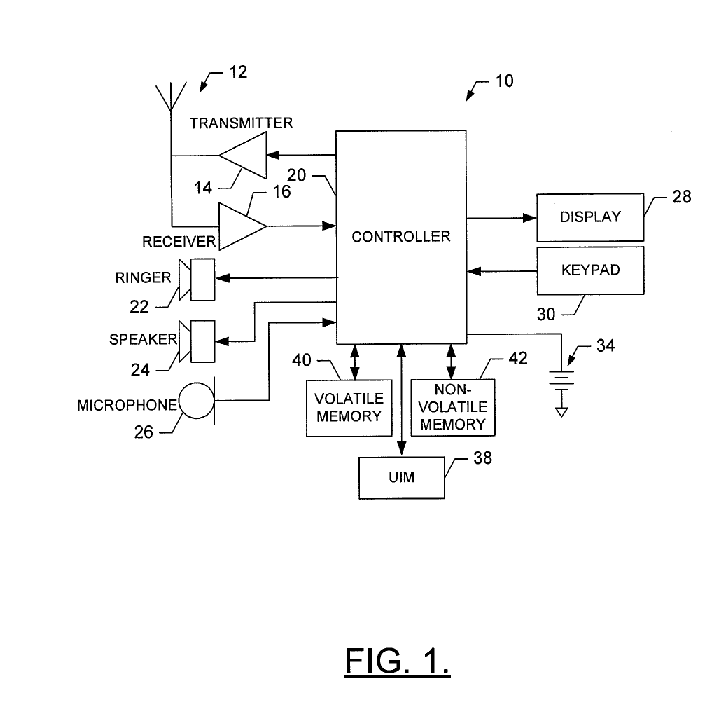

FIG. 1, one exemplary embodiment of the invention, illustrates a block diagram of a mobile terminal 10 that may benefit from embodiments of the present invention. It should be understood, however, that a mobile telephone as illustrated and hereinafter described is merely illustrative of one type of mobile terminal that may benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radio, GPS devices, or any combination of the aforementioned, and other types of communications systems, can readily employ embodiments of the present invention.

In addition, while several embodiments of the method of the present invention may be performed or used by or in connection with a mobile terminal 10, the method may be employed by or used in connection with devices other than a mobile terminal (e.g., personal computers (PCs), servers, or the like). Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved- universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

It is understood that the apparatus, such as the controller 20, may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), smart card, etc. The UIM 38 typically stores information elements related to a mobile subscriber (e.g., the IMSI, TMSI, PTMSI and/or the like). In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

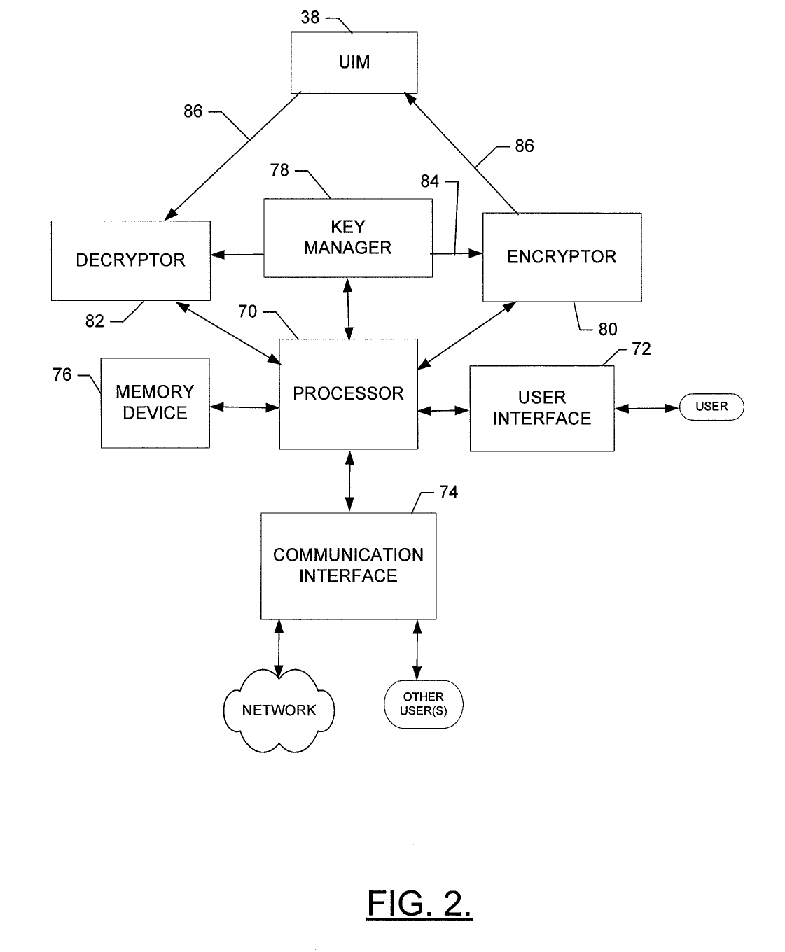

An exemplary embodiment of the invention will now be described with reference to FIG. 2, in which certain elements of an apparatus for providing trusted storage of temporary subscriber data are displayed. The apparatus of FIG. 2 may be employed, for example, on the mobile terminal 10 of FIG. 1. However, it should be noted that the apparatus of FIG. 2, may also be employed on a variety of other devices, both mobile and fixed, and therefore, the present invention should not be limited to application on devices such as the mobile terminal 10 of FIG. 1. Alternatively, embodiments may be employed on a combination of devices including, for example, those listed above. Accordingly, embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 2, an apparatus for providing trusted storage of temporary subscriber data is provided. The apparatus may include or otherwise be in communication with a processor 70, a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit) or an FPGA (field programmable gate array). The processor 70 may be configured to execute instructions stored in the memory device 76 or otherwise accessible to the processor 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

In an exemplary embodiment, the processor 70 may be embodied as, include or otherwise control a key manager 78, an encryption manager 80, and a decryption manager 82. The key manager 78, the encryption manager 80, and the decryption manager 82 may each be any means such as a device or circuitry embodied in hardware, software or a combination of hardware and software that is configured to perform the corresponding functions of the key manager 78, the encryption manager 80, and the decryption manager 82, respectively, as described below.

The key manager 78 may be configured to manage the storage and/or clearance of a key or keys for use in encryption/decryption (e.g., by the encryption manager 80 and the decryption manager 82, respectively). In an exemplary embodiment, the key manager 78 may store a key or keys within the memory device 76 and provide the encryption manager 80 and/or the decryption manager 82 with access to the key or keys for use by the encryption manager 80 and/or the decryption manager 82 in encryption/decryption operations. In some exemplary cases, the key or keys may be randomly generated according to any suitable algorithm for random key generation that may be executed by the key manager 78. The operation of the key manager 78 with respect to random key generation and/or key clearance may be predefined using hardware or software to define conditions under which random key generation occurs or key clearance is conducted. Alternatively, the operation of the key manager 78 with respect to random key generation or clearance may be changeable subject to instructions received by a user, by a network entity, or generated by an internal algorithm.

In an exemplary embodiment, the key manager 78 may be configured to store a random key used for encryption by the encryption manager 80 in the memory device 76. The encrypted data may be stored on the UIM 38. The key manager 78 may be further configured to provide the decryption manager 82 with information based on the random key to enable the decryption manager 82 to decrypt the stored encrypted data from the UIM 38. In an exemplary embodiment, the key manager 78 may clear or replace the encryption key after utilizing the encryption key for decrypting the encrypted data.

The encryption manager 80 may be configured to encrypt data according to an encryption key provided by the key manager 78. In some embodiments, the key manager 78 may simply identify a key to be used, or a location of a key to be used, to the encryption manager 80 for the encryption manager 80 to use the key to encrypt a particular value. In an exemplary embodiment, the encryption manager 80 may be configured to utilize a random encryption key 84 identified by the key manager 78 for encrypting a value indicative of a temporary identity of a particular entity that is received from a network device. An encrypted value 86 generated from the encryption of the value may then be communicated to the UIM 38 for storage.

In an exemplary embodiment, the value may be an identification mechanism used between the mobile terminal employing the UIM 38 and the network in which the mobile terminal is operating. Thus, according to operations without the encryption manager 80, the network may provide the value (e.g., a TMSI or PTMSI) to the mobile terminal and the mobile terminal may store the value in the UIM 38. The value may then be used for subsequent communications, such as by the mobile terminal accessing the value from the UIM 38 to provide the value to the network (e.g., via the communication interface 74). However, with the employment of the encryption manager 80, the value is encrypted and the encrypted value 86 is instead stored on the UIM 38. Thus, if the mobile terminal communicates the value to the network for any reason, the encrypted value 86 may first be decrypted to enable provision of the value to the network instead of the encrypted value 86. Accordingly, the decryption manager 82 may be employed to perform the above mentioned decryption.

The decryption manager 82 may be configured to decrypt data based on the encryption key provided by the key manager 78. In some embodiments, the key manager 78 may simply identify a key to be used, or a location of a key to be used, to the decryption manager 82 for the decryption manager 82 to use the key to decrypt the encrypted value 86 to recover the value. In an exemplary embodiment, the decryption manager 82 may be configured to perform an inverse of the encryption employed by the encryption manager 80 on the encrypted value 86 when the encrypted value 86 is read out of the UIM 38. In some cases, after the encrypted value 86 is read out of the UIM 38, for example, for communication to the network, the random encryption key 84 may then be cleared. As such, each time the decryption manager 82 is employed to enable reading out of the value (e.g., by decrypting the encrypted value 86), the random encryption key 84 may be cleared (or otherwise destroyed) as a security enhancement effort. As an alternative, instead of clearing the random encryption key 84, the random encryption key 84 could be replaced. In either case, according to an exemplary embodiment, the random encryption key 84 may not be used more than once for reading out and decrypting the encrypted value 86.

In an exemplary embodiment, if there is no random encryption key 84 currently stored, the value may be considered cleared when the value is read. Thus, if when attempting to read the encrypted value 86 out of the UIM 38 the decryption manager 82 notices a cleared value for the random encryption key 84, the decryption manager 82 may provide an incorrect value to the network. The network and mobile terminal may then use a different value such as the IMSI for location updating if the value (e.g., a TMSI) that is not valid is provided. Thus, for example, operation of the mobile terminal with the network may not be permitted.

In the context of a smart card application as described above, in which the UIM 38 is a general device (an example of which may be a SIM card) capable of storing identity information about a user or subscriber, the value may be temporary subscriber identity information such as a TMSI (or PTMSI) and the encrypted value 86 may be an encrypted TMSI (or encrypted PTMSI). Thus, the UIM 38 may store the encrypted TMSI. However, the UIM 38 is not necessarily aware (since there is no need to modify operation of the UIM 38) that an encrypted TMSI has been stored thereon, and thus if the UIM 38 is removed and, for example, placed in a different mobile terminal, any attempt to use the encrypted TMSI may be likely to result in the provision of an encrypted (or improperly decrypted) and therefore incorrect or invalid TMSI to the network of the different mobile terminal. Thus, if the SIM lock were bypassed on the different mobile terminal, the encryption of the TMSI may still prevent improper usage of the UIM 38 or the different mobile terminal. The encryption of the TMSI thus provides for storage of a value that is not useable for enabling network communications without the corresponding encryption key. However, since the encryption key is not stored either in the UIM 38 or transmitted over an air interface, the encryption key may be secure by being known only to the mobile terminal employing an embodiment of the present invention.

In some exemplary scenarios, embodiments of the present invention may provide that if, for example, the UIM 38 is changed to another mobile terminal (or a different UIM is inserted in the mobile terminal), the TMSI will appear to be corrupted since when the encrypted TMSI is read out of the UIM 38 the encrypted TMSI may not be properly decrypted due to the random encryption key used to encode the TMSI not being available for reading out and decrypting of the TMSI. In this situation, location updating may be attempted with the IMSI. In another scenario in which the phone is switched on and a new TMSI is not stored because a new TMSI is not allocated, the TMSI may be cleared. In this situation as well, location updating may be attempted with the IMSI.

A more specific example of an operation with respect to one exemplary embodiment employing a TMSI as the value indicative of the temporary identity of a particular entity provided by a network device will now be described for purposes of illustration and not of limitation. In this regard, for example, a locked mobile terminal may have a separate random encryption key for each of a TMSI and a PTMSI (although the same key could be used for both in some embodiments). The random key for the TMSI may be TR1, while the random key for the PTMSI may be PR1. The values of both TR1 and PR1 may initially be cleared (e.g., TR1=“cleared”, PR1=“cleared”).

When a SIM card (as an example of a UIM) is inserted into the mobile terminal, normal SIM lock checks may be performed. As such, for example, the IMSI may be checked and the TMSI and PTMSI may be read. If SIM lock checks are not passed, the mobile terminal may consider the SIM to be not applicable and may not allow usage of the SIM. On the other hand, if SIM lock checks are passed, temporary subscription identities (e.g., TMSI and PTMSI) may initially be cleared and remain cleared. However, even if some valid TMSI and/or PTMSI value is already stored on the SIM, if the TR1 and PR1 are cleared, the values of the TMSI and/or PTMSI may be considered cleared anyway. Thus, if the mobile terminal tries to register with a network, the registration may be done via IMSI. If the IMSI was faked (e.g., via an X-SIM), a security mechanism of the network (e.g., authentication) may ensure that the mobile terminal is not provided with service on the basis of the faked IMSI.

If the IMSI provided is real and registration succeeds, the network may typically allocate a new temporary subscription identity (e.g., TMSI and/or PTMSI) to be stored at the SIM in the future. However, instead of storing the temporary subscription identity in the SIM in plain text, the temporary subscription identity may be encrypted (e.g., via the encryption manager 80) with a random key (e.g., the random encryption key 84) to provide an encrypted temporary subscription identity (e.g., the encrypted value 86).

Thus, for example, if any new TMSI is provided to the mobile terminal, the TMSI may be stored subsequent to application of a random key (e.g., via the key manager 78), which may then be stored as TR1 (e.g., to permanent memory such as a portion of the memory device 76). Likewise, if any new PTMSI is provided to the mobile terminal, the PTMSI may be stored subsequent to application of a random key, which may then be stored as PRI. The random keys could be stored, for example, when the temporary subscriber identities are changed or when the mobile terminal is powered off. In some embodiments, the random keys may be changed in response to the receipt of new temporary subscriber identity information when the phone is powered on or at configurable intervals. Alternatively, the random keys could remain the same. In some embodiments, the key may be changed at power off because the mobile terminal may not actually re-read TMSI or PTMSI from the SIM card, so there may be little reason for decrypting TMSI or PTMSI several times. Thus, for example, cached RAM copies of the TMSI or PTMSI may be used.

When the mobile terminal is switched on and the mobile terminal has TR1 and/or PRI with values other than “cleared” during reading the TMSI or some other encrypted subscriber data, the following may occur:

If TMSI is cleared, TMSI may be considered to be cleared and TRI key may be destroyed;
If PTMSI is cleared, PTMSI may be considered to be cleared and PRI key may be destroyed;
If TMSI is not cleared, TMSI may be considered as encrypted with key TR1 and key TR1 may be sued with a reverse algorithm to decrypt the encrypted TMSI. The TR1 key may then be destroyed by clearing the TR1 key.
If PTMSI is not cleared, PTMSI may be considered as encrypted with key PR1 and key PR1 may be sued with a reverse algorithm to decrypt the encrypted PTMSI. The PR1 key may then be destroyed by clearing the PR1 key.

If a temporary subscriber identity is not decoded using the same key used to encrypt the temporary subscriber identity prior to storage of the temporary subscriber identity, an invalid temporary subscriber identity will be provided to the network. The normal security mechanisms of the network may then request the IMSI in order to determine the subscriber identity. As indicated above, if the IMSI was faked (e.g., by an X-SIM card), the network security mechanism will typically disallow using the corresponding SIM card.

In an exemplary embodiment, additional capabilities may be added. For example, in some cases, the key manager 78 may be configured to notice or detect a UIM or smart card change. In response to detection of a UIM change, the key manager 78 may direct the deletion of the random keys (e.g., TR1 and PR1). Accordingly, after deletion of the random keys, the temporary subscriber identity information may be considered clears and IMSI registration may be performed instead of registration attempted with a potentially corrupted temporary subscriber identity.

In another exemplary embodiment, more than just the temporary subscriber identity information may be encrypted in order to reduce the possibility of a stored and encrypted value being decoded with the wrong key, but coincidentally matching a valid temporary subscriber identity. For example, an encrypted TMSI could be decrypted using a key other than the key used to encrypt the TMSI. Thus, the resultant TMSI will not match the original valid TMSI sent to the mobile terminal. However, in rare instances, the resultant TMSI may still match some other valid TMSI. In order to further reduce the likelihood of such an event occurring, the encryption manager 80 may be further configured to encrypt additional information such as location information including location area information (LAI). By encrypting more total bits (e.g., the bits of the TMSI and the bits of the LAI), the likelihood of having a coincidental valid TMSI may be reduced.

In another exemplary embodiment, a checksum value may be stored in the memory device 76 by the key manager 78. The checksum value may be used to compare to decoded temporary subscriber identity information or location information (or even other unused fields) for checking the validity of a decoded value. In some embodiments, an indicator (e.g., a particular bit such as a reserved for future use bit) may be used to indicate whether the temporary subscriber identity (and possibly also location information) are decoded.

Thus, embodiments of the present invention may enable an enhancement to the effectiveness of SIM lock features by reducing the ease of use of X-SIM at unlocking mobile terminals for networks other than the network to which the mobile terminal is locked. Moreover, embodiments of the present invention may be utilized without any need for network or smart card changes.

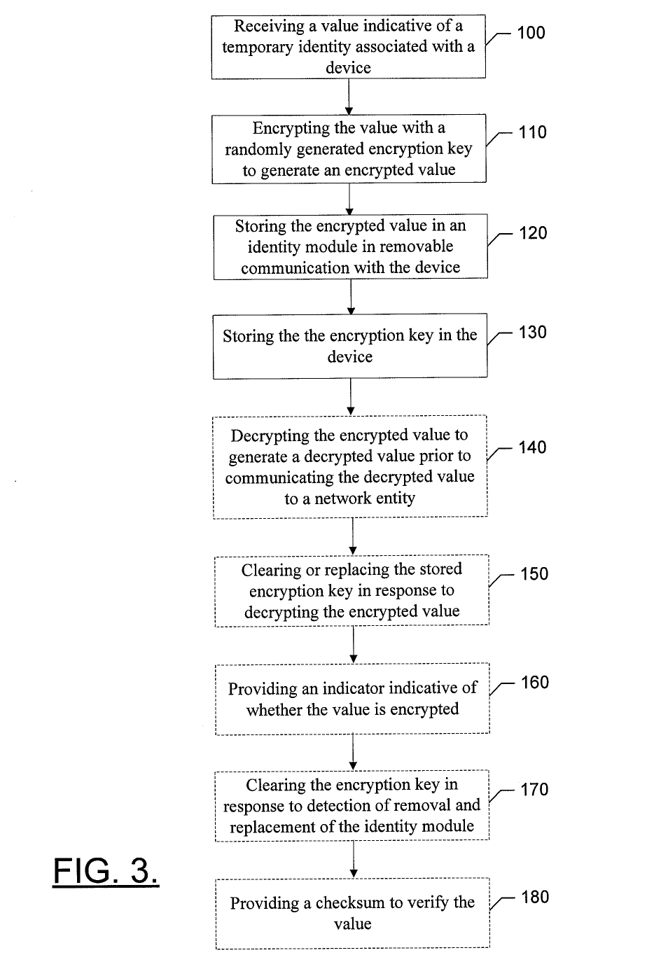

FIG. 3 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or other apparatus employing embodiments of the present invention and executed by a processor in the mobile terminal or other apparatus. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing trusted storage of temporary subscriber data as illustrated, for example, in FIG. 3 may include receiving a value indicative of a temporary identity associated with a device at operation 100 and encrypting the value with a randomly generated encryption key to generate an encrypted value at operation 110. The method may further include storing the encrypted value in an identity module in removable communication with the device (e.g., a UIM, SIM, smart card, etc.) at operation 120 and storing the encryption key in the device at operation 130.

In an exemplary embodiment, the method may include further optional operations as well, some examples of which are shown in FIG. 3 in dashed lines. Of note, the ordering of the optional operations should not be taken as being significant since some such operations may not be performed at all or may be performed in a different order. Additional exemplary operations may include operation 140 of decrypting the encrypted value to generate a decrypted value prior to communicating the decrypted value to a network entity. The decryption may include decrypting the encrypted value based on the stored encryption key. In another exemplary embodiment, the method may include clearing the stored encryption key in response to decrypting the encrypted value or replacing the stored encryption key with a new encryption key in response to decrypting the encrypted value at operation 150. In an exemplary embodiment, the method may further include providing an indicator indicative of whether the value is encrypted at operation 160, clearing the encryption key in response to detection of removal and replacement of the identity module at operation 170, or providing a checksum to verify the value at operation 180.

In some embodiments, receiving the value may include receiving one of a temporary mobile subscriber identity (TMSI) or a packet TMSI (PTMSI) at a mobile terminal including the identity module. In an exemplary embodiment, encrypting the value may further include encrypting at least a portion of location area information in addition to the encrypting of the value.

In an exemplary embodiment, an apparatus for performing the method of FIG. 3 above may comprise a processor (e.g., the processor 70) configured to perform each of the operations (100-180) described above. The processor may, for example, be configured to perform the operations (100-180) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100 to 180 may comprise, for example, the processor 70, respective ones of the key manager 78, the encryption manager 80 and the decryption manager 82, or an algorithm executed by the processor for controlling the application of an encryption key prior to storing a temporary subscriber identity in a removable card such as a smart card as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a value indicative of a temporary identity associated with a device;
encrypting the value with a randomly generated encryption key to generate an encrypted value;
storing the encrypted value in an identity module in removable communication with the device; and
storing the encryption key in the device.

2. The method of claim 1, further comprising decrypting the encrypted value to generate a decrypted value prior to communicating the decrypted value to a network entity.

3. The method of claim 2, wherein decrypting the encrypted value comprises decrypting the encrypted value based on the stored encryption key.

4. The method of claim 2, further comprising clearing the stored encryption key in response to decrypting the encrypted value.

5. The method of claim 2, further comprising replacing the stored encryption key with a new encryption key in response to decrypting the encrypted value.

6. The method of claim 1, wherein receiving the value comprises receiving one of a temporary mobile subscriber identity (TMSI) or a packet TMSI (PTMSI) at a mobile terminal including the identity module.

7. The method of claim 1, wherein encrypting the value further comprises encrypting at least a portion of location area information in addition to the encrypting of the value.

8. The method of claim 1, further comprising providing an indicator indicative of whether the value is encrypted.

9. The method of claim 1, further comprising clearing the encryption key in response to detection of removal and replacement of the identity module.

10. The method of claim 1, further comprising providing a checksum to verify the value.

11. An apparatus comprising a processor configured to:
receive a value indicative of a temporary identity associated with a device;
encrypt the value with a randomly generated encryption key to generate an encrypted value;
store the encrypted value in an identity module in removable communication with the device; and
store the encryption key in the device.

12. The apparatus of claim 11, wherein the processor is further configured to decrypt the encrypted value to generate a decrypted value prior to communicating the decrypted value to a network entity.

13. The apparatus of claim 12, wherein the processor is configured to decrypt the encrypted value by decrypting the encrypted value based on the stored encryption key.

14. The apparatus of claim 12, wherein the processor is further configured to clear the stored encryption key in response to decrypting the encrypted value.

15. The apparatus of claim 12, wherein the processor is further configured to replace the stored encryption key with a new encryption key in response to decrypting the encrypted value.

16. The apparatus of claim 11, wherein the processor is configured to receive the value by receiving one of a temporary mobile subscriber identity (TMSI) or a packet TMSI (PTMSI) at a mobile terminal including the identity module.

17. The apparatus of claim 11, wherein the processor is configured to encrypt the value further by encrypting at least a portion of location area information in addition to the encrypting of the value.

18. The apparatus of claim 11, wherein the processor is further configured to provide an indicator indicative of whether the value is encrypted.

19. The apparatus of claim 11, wherein the processor is further configured to clear the encryption key in response to detection of removal and replacement of the identity module.

20. The apparatus of claim 11, wherein the processor is further configured to providing a checksum to verify the value.

21. A computer program product comprising at least one computer-readable storage medium having computer-executable program code portions stored therein, the computer-executable program code portions comprising:
a first program code portion for receiving a value indicative of a temporary identity associated with a device;
a second program code portion for encrypting the value with a randomly generated encryption key to generate an encrypted value;
a third program code portion for storing the encrypted value in an identity module in removable communication with the device; and
a fourth program code portion for storing the encryption key in the device.

22. The computer program product of claim 21, further comprising a fifth program code portion for decrypting the encrypted value to generate a decrypted value prior to communicating the decrypted value to a network entity.

23. The computer program product of claim 22, wherein the fifth program code portion includes instructions for decrypting the encrypted value based on the stored encryption key.

24. The computer program product of claim 22, further comprising a sixth program code portion for clearing the stored encryption key in response to decrypting the encrypted value.

25. The computer program product of claim 22, further comprising a sixth program code portion for replacing the stored encryption key with a new encryption key in response to decrypting the encrypted value.

26. The computer program product of claim 21, wherein the first program code portion includes instructions for receiving one of a temporary mobile subscriber identity (TMSI) or a packet TMSI (PTMSI) at a mobile terminal including the identity module.

27. The computer program product of claim 21, wherein the second program code portion includes instructions for encrypting the value further comprises encrypting at least a portion of location area information in addition to the encrypting of the value.

28. The computer program product of claim 21, further comprising a fifth program code portion for providing an indicator indicative of whether the value is encrypted.

29. The computer program product of claim 21, further comprising a fifth program code portion for clearing the encryption key in response to detection of removal and replacement of the identity module.

30. The computer program product of claim 21, further comprising a fifth program code portion for providing a checksum to verify the value.

31. An apparatus comprising:
means for receiving a value indicative of a temporary identity associated with a device;
means for encrypting the value with a randomly generated encryption key to generate an encrypted value;
means for storing the encrypted value in an identity module in removable communication with the device; and
means for storing the encryption key in the device.

32. The apparatus of claim 31, further comprising means for decrypting the encrypted value to generate a decrypted value prior to communicating the decrypted value to a network entity.
